(19) United States
(12) Patent Application Publication
(10) Pub. No.: US 2024/0040347 A1
(43) Pub. Date: Feb. 1, 2024

(54) Methods, Apparatuses, and Computer Readable Media for Binding and De-Binding Neighboring Apparatuses

(71) Applicant: Nokia Solutions and Networks Oy, Espoo (FI)

(72) Inventors: Xiaobing LENG, Shanghai (CN); Li LI, Shanghai (CN); Chenhui YE, Shanghai (CN); Jianguo LIU, Shanghai (CN); Wenyi XU, Shanghai (CN); Fei GAO, Shanghai (CN)

(21) Appl. No.: 18/265,290

(22) PCT Filed: Dec. 3, 2020
(86) PCT No.: PCT/CN2020/133578

§ 371 Date: Jun. 5, 2023

(51) Int. Cl. H04W 4/38; H04W 4/02

(52) U.S. Cl. CPC H04W 4/38; H04W 4/027

(57) ABSTRACT

Disclosed are methods, apparatuses, and computer readable media for binding neighboring apparatuses. An example apparatus may include at least one processor and at least one memory. The at least one memory may include computer program code, and the at least one memory and the computer program code may be configured to, with the at least one processor, cause the apparatus to perform transmitting, to a management entity, a binding request for binding with at least one neighboring apparatus, and receiving, from the management entity, a binding response to the binding request.

### TECHNICAL FIELD

Various embodiments relate to methods, apparatuses, and computer readable media for binding and de-binding neighboring apparatuses.

### BACKGROUND

In most of the time, goods with hyper tags are always transported or stacked together. These grouped goods are under the same space and their hyper tags will measure the same or very similar results on position related information (e.g. location, velocity, acceleration, etc.) and environment perception related information (e.g. barometric pressure, temperature, humility etc.).

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is an apparatus. The apparatus may include at least one processor and at least one memory. The at least one memory may include computer program code, and the at least one memory and the computer program code may be configured to, with the at least one processor, cause the apparatus to perform transmitting, to a management entity, a binding request for binding with at least one neighboring apparatus, and receiving, from the management entity, a binding response to the binding request.

In some embodiments, the transmitting, to a management entity, a binding request for binding with at least one neighboring apparatus may be triggered by a predetermined event.

In some embodiments, the binding request may include at least one of an indicator of the binding request, at least one identity of the at least one neighboring apparatus, at least one binding information type, and at least one binding reason.

In some embodiments, the binding response may include at least one of acknowledge or negative acknowledge of the binding request, at least one binding information type, and at least one identity of the at least one neighboring apparatus.

In some embodiments, the at least one memory and the computer program code may be further configured to, with the at least one processor, cause the apparatus to further perform searching the at least one neighboring apparatus, and acquiring the at least one identity of the at least one neighboring apparatus.

In some embodiments, the at least one memory and the computer program code may be further configured to, with the at least one processor, cause the apparatus to further perform transmitting, to the management entity, a binding release request for de-binding with the at least one neighboring apparatus, and receiving, from the management entity, a binding release response to the binding release request.

In some embodiments, the binding release request may include at least one of an indicator of the binding release request, at least one binding information type to be release, and at least one binding release reason.

In some embodiments, the binding release response may include at least one of acknowledge of the binding release request, and at least one released binding information type.

In a second aspect, disclosed is an apparatus. The apparatus may include at least one processor and at least one memory. The at least one memory may include computer program code, and the at least one memory and the computer program code may be configured to, with the at least one processor, cause the apparatus to perform receiving, from a management entity, a capacity request for binding capacity with a neighboring apparatus, and transmitting, to the management entity, a capacity response to the capacity request.

In some embodiments, the capacity request may include at least one binding information type.

In some embodiments, the capacity response may include at least one of at least one supported binding information type, at least one rejected binding information type, and at least one reject reason.

In some embodiments, the at least one memory and the computer program code may be further configured to, with the at least one processor, cause the apparatus to further perform receiving binding information from the management entity.

In some embodiments, the binding information may include at least one of an identity of the neighboring apparatus, and at least one binding information type.

In some embodiments, the at least one memory and the computer program code may be further configured to, with the at least one processor, cause the apparatus to further perform transmitting, to the management entity, a binding release request for de-binding with the neighboring apparatus, and receiving, from the management entity, a binding release response to the binding release request.

In some embodiments, the binding release request may include at least one of an indicator of the binding release request, the identity of the neighboring apparatus, at least one binding information type to be release, and at least one binding release reason.

In some embodiments, the binding release response may include at least one of acknowledge of the binding release request, and at least one binding information type to be released.

In a third aspect, disclosed is an apparatus. The apparatus may include at least one processor and at least one memory. The at least one memory may include computer program code, and the at least one memory and the computer program code may be configured to, with the at least one processor, cause the apparatus to perform receiving, from a first apparatus, a binding request for binding with at least one neighboring apparatus of the first apparatus, transmitting, to a second apparatus of the at least one neighboring apparatus, a first capacity request for a binding capacity of the second apparatus, in response to the binding request, receiving, from the second apparatus, a first capacity response to the first capacity request, binding the first apparatus and the second apparatus based on the first capacity response, and transmitting, to the first apparatus, a binding response to the binding request.

In some embodiments, the binding request may include at least one of an indicator of the binding request, at least one identity of the at least one neighboring apparatus, at least one binding information type, and at least one binding reason.

In some embodiments, the binding response may include at least one of acknowledge or negative acknowledge of the binding request, at least one binding information type, and an identity of the second apparatus.

In some embodiments, the at least one memory and the computer program code may be further configured to, with the at least one processor, cause the apparatus to further perform receiving an access request for first measurement information of the first apparatus, transmitting the access request to the second apparatus, receiving second measurement information of the second apparatus, and determining the first measurement information based on the second measurement information and a calibration parameter.

In some embodiments, the binding the first apparatus and the second apparatus based on the first capacity response may include establishing an association between the first apparatus and at least one of an identity of the second apparatus, a binding information type, a calibration parameter, and binding establishment time.

In some embodiments, the at least one memory and the computer program code may be further configured to, with the at least one processor, cause the apparatus to further perform transmitting first binding information to the second apparatus, and the first binding information may include at least one of an identity of the first apparatus, and at least one binding information type.

In some embodiments, the at least one memory and the computer program code may be further configured to, with the at least one processor, cause the apparatus to further perform receiving, from one of the first apparatus and the second apparatus, a binding release request for de-binding the first apparatus and the second apparatus, deleting an association between the first apparatus and at least one of an identity of the second apparatus, a binding information type, a calibration parameter, and binding establishment time, based on the binding release request, transmitting, to the one of the first apparatus and the second apparatus, a binding release response to the binding release request, and transmitting, to another one of the first apparatus and the second apparatus, binding release information or binding update information.

In some embodiments, the binding release request may include at least one of an indicator of the binding release request, an identity of the first apparatus, at least one binding information type to be release, and at least one binding release reason.

In some embodiments, the binding release response may include at least one of acknowledge of the binding release request, and at least one released binding information type.

In some embodiments, the binding release information may include at least one released binding information type.

In some embodiments, the at least one memory and the computer program code may be further configured to, with the at least one processor, cause the apparatus to further perform transmitting, to a third apparatus of the at least one neighboring apparatus, a second capacity request for binding capacity of the third apparatus, in response to the binding release request from the second apparatus, receiving, from the third apparatus, a second capacity response to the second capacity request, and binding the first apparatus and the third apparatus based on the second capacity response.

In some embodiments, the binding update information may include at least one of at least one binding information type, and an identity of the third apparatus.

In some embodiments, the at least one memory and the computer program code may be further configured to, with the at least one processor, cause the apparatus to further perform transmitting second binding information to the third apparatus, and the second binding information may include at least one of an identity of the first apparatus, and at least one binding information type.

In some embodiments, the first capacity request or the second capacity request may include at least one binding information type.

In some embodiments, the first capacity response or the second capacity response may include at least one of at least one supported binding information type, at least one rejected binding information type, and at least one reject reason.

In a fourth aspect, disclosed is a method. The method may include transmitting, to a management entity, a binding request for binding with at least one neighboring apparatus, and receiving, from the management entity, a binding response to the binding request.

In some embodiments, the transmitting, to a management entity, a binding request for binding with at least one neighboring apparatus may be triggered by a predetermined event.

In some embodiments, the binding request may include at least one of an indicator of the binding request, at least one identity of the at least one neighboring apparatus, at least one binding information type, and at least one binding reason.

In some embodiments, the binding response may include at least one of acknowledge or negative acknowledge of the binding request, at least one binding information type, and at least one identity of the at least one neighboring apparatus.

In some embodiments, the method may further include searching the at least one neighboring apparatus, and acquiring the at least one identity of the at least one neighboring apparatus.

In some embodiments, the method may further include transmitting, to the management entity, a binding release request for de-binding with the at least one neighboring apparatus, and receiving, from the management entity, a binding release response to the binding release request.

In some embodiments, the binding release request may include at least one of an indicator of the binding release request, at least one binding information type to be release, and at least one binding release reason.

In some embodiments, the binding release response may include at least one of acknowledge of the binding release request, and at least one released binding information type.

In a fifth aspect, disclosed is a method. The method may include receiving, from a management entity, a capacity request for binding capacity with a neighboring apparatus, and transmitting, to the management entity, a capacity response to the capacity request.

In some embodiments, the capacity request may include at least one binding information type.

In some embodiments, the capacity response may include at least one of at least one supported binding information type, at least one rejected binding information type, and at least one reject reason.

In some embodiments, the method may further include receiving binding information from the management entity.

In some embodiments, the binding information may include at least one of an identity of the neighboring apparatus, and at least one binding information type.

In some embodiments, the method may further include transmitting, to the management entity, a binding release request for de-binding with the neighboring apparatus, and receiving, from the management entity, a binding release response to the binding release request.

In some embodiments, the binding release request may include at least one of an indicator of the binding release request, the identity of the neighboring apparatus, at least one binding information type to be release, and at least one binding release reason.

In some embodiments, the binding release response may include at least one of acknowledge of the binding release request, and at least one binding information type to be released.

In a sixth aspect, disclosed is a method. The method may include receiving, from a first apparatus, a binding request for binding with at least one neighboring apparatus of the first apparatus, transmitting, to a second apparatus of the at least one neighboring apparatus, a first capacity request for a binding capacity of the second apparatus, in response to the binding request, receiving, from the second apparatus, a first capacity response to the first capacity request, binding the first apparatus and the second apparatus based on the first capacity response, and transmitting, to the first apparatus, a binding response to the binding request.

In some embodiments, the binding request may include at least one of an indicator of the binding request, at least one identity of the at least one neighboring apparatus, at least one binding information type, and at least one binding reason.

In some embodiments, the binding response may include at least one of acknowledge or negative acknowledge of the binding request, at least one binding information type, and an identity of the second apparatus.

In some embodiments, the method may further include receiving an access request for first measurement information of the first apparatus, transmitting the access request to the second apparatus, receiving second measurement information of the second apparatus, and determining the first measurement information based on the second measurement information and a calibration parameter.

In some embodiments, the binding the first apparatus and the second apparatus based on the first capacity response may include establishing an association between the first apparatus and at least one of an identity of the second apparatus, a binding information type, a calibration parameter, and binding establishment time.

In some embodiments, the method may further include transmitting first binding information to the second apparatus, and the first binding information may include at least one of an identity of the first apparatus, and at least one binding information type.

In some embodiments, the method may further include receiving, from one of the first apparatus and the second apparatus, a binding release request for de-binding the first apparatus and the second apparatus, deleting an association between the first apparatus and at least one of an identity of the second apparatus, a binding information type, a calibration parameter, and binding establishment time, based on the binding release request, transmitting, to the one of the first apparatus and the second apparatus, a binding release response to the binding release request, and transmitting, to another one of the first apparatus and the second apparatus, binding release information or binding update information.

In some embodiments, the binding release request may include at least one of an indicator of the binding release request, an identity of the first apparatus, at least one binding information type to be release, and at least one binding release reason.

In some embodiments, the binding release response may include at least one of acknowledge of the binding release request, and at least one released binding information type.

In some embodiments, the binding release information may include at least one released binding information type.

In some embodiments, the method may further include transmitting, to a third apparatus of the at least one neighboring apparatus, a second capacity request for binding capacity of the third apparatus, in response to the binding release request from the second apparatus, receiving, from the third apparatus, a second capacity response to the second capacity request, and binding the first apparatus and the third apparatus based on the second capacity response.

In some embodiments, the binding update information may include at least one of at least one binding information type, and an identity of the third apparatus.

In some embodiments, the method may further include transmitting second binding information to the third apparatus, and the second binding information may include at least one of an identity of the first apparatus, and at least one binding information type.

In some embodiments, the first capacity request or the second capacity request may include at least one binding information type.

In some embodiments, the first capacity response or the second capacity response may include at least one of at least one supported binding information type, at least one rejected binding information type, and at least one reject reason.

In a seventh aspect, disclosed is an apparatus. The apparatus may include means for transmitting, to a management entity, a binding request for binding with at least one neighboring apparatus, and means for receiving, from the management entity, a binding response to the binding request.

In some embodiments, the transmitting, to a management entity, a binding request for binding with at least one neighboring apparatus may be triggered by a predetermined event.

In some embodiments, the binding request may include at least one of an indicator of the binding request, at least one identity of the at least one neighboring apparatus, at least one binding information type, and at least one binding reason.

In some embodiments, the binding response may include at least one of acknowledge or negative acknowledge of the binding request, at least one binding information type, and at least one identity of the at least one neighboring apparatus.

In some embodiments, the apparatus may further include means for searching the at least one neighboring apparatus, and means for acquiring the at least one identity of the at least one neighboring apparatus.

In some embodiments, the apparatus may further include means for transmitting, to the management entity, a binding release request for de-binding with the at least one neighboring apparatus, and means for receiving, from the management entity, a binding release response to the binding release request.

In some embodiments, the binding release request may include at least one of an indicator of the binding release request, at least one binding information type to be release, and at least one binding release reason.

In some embodiments, the binding release response may include at least one of acknowledge of the binding release request, and at least one released binding information type.

In an eighth aspect, disclosed is an apparatus. The apparatus may include means for receiving, from a management entity, a capacity request for binding capacity with a neighboring apparatus, and means for transmitting, to the management entity, a capacity response to the capacity request.

In some embodiments, the capacity request may include at least one binding information type.

In some embodiments, the capacity response may include at least one of at least one supported binding information type, at least one rejected binding information type, and at least one reject reason.

In some embodiments, the apparatus may further include means for receiving binding information from the management entity.

In some embodiments, the binding information may include at least one of an identity of the neighboring apparatus, and at least one binding information type.

In some embodiments, the apparatus may further include means for transmitting, to the management entity, a binding release request for de-binding with the neighboring apparatus, and means for receiving, from the management entity, a binding release response to the binding release request.

In some embodiments, the binding release request may include at least one of an indicator of the binding release request, the identity of the neighboring apparatus, at least one binding information type to be release, and at least one binding release reason.

In some embodiments, the binding release response may include at least one of acknowledge of the binding release request, and at least one binding information type to be released.

In a ninth aspect, disclosed is an apparatus. The apparatus may include means for receiving, from a first apparatus, a binding request for binding with at least one neighboring apparatus of the first apparatus, means for transmitting, to a second apparatus of the at least one neighboring apparatus, a first capacity request for a binding capacity of the second apparatus, in response to the binding request, means for receiving, from the second apparatus, a first capacity response to the first capacity request, means for binding the first apparatus and the second apparatus based on the first capacity response, and means for transmitting, to the first apparatus, a binding response to the binding request.

In some embodiments, the binding request may include at least one of an indicator of the binding request, at least one identity of the at least one neighboring apparatus, at least one binding information type, and at least one binding reason.

In some embodiments, the binding response may include at least one of acknowledge or negative acknowledge of the binding request, at least one binding information type, and an identity of the second apparatus.

In some embodiments, the apparatus may further include means for receiving an access request for first measurement information of the first apparatus, means for transmitting the access request to the second apparatus, means for receiving second measurement information of the second apparatus, and means for determining the first measurement information based on the second measurement information and a calibration parameter.

In some embodiments, the binding the first apparatus and the second apparatus based on the first capacity response may include establishing an association between the first apparatus and at least one of an identity of the second apparatus, a binding information type, a calibration parameter, and binding establishment time.

In some embodiments, the apparatus may further include means for transmitting first binding information to the second apparatus, and the first binding information may include at least one of an identity of the first apparatus, and at least one binding information type.

In some embodiments, the apparatus may further include means for receiving, from one of the first apparatus and the second apparatus, a binding release request for de-binding the first apparatus and the second apparatus, means for deleting an association between the first apparatus and at least one of an identity of the second apparatus, a binding information type, a calibration parameter, and binding establishment time, based on the binding release request, means for transmitting, to the one of the first apparatus and the second apparatus, a binding release response to the binding release request, and means for transmitting, to another one of the first apparatus and the second apparatus, binding release information or binding update information.

In some embodiments, the binding release request may include at least one of an indicator of the binding release request, an identity of the first apparatus, at least one binding information type to be release, and at least one binding release reason.

In some embodiments, the binding release response may include at least one of acknowledge of the binding release request, and at least one released binding information type.

In some embodiments, the binding release information may include at least one released binding information type.

In some embodiments, the apparatus may further include means for transmitting, to a third apparatus of the at least one neighboring apparatus, a second capacity request for binding capacity of the third apparatus, in response to the binding release request from the second apparatus, means for receiving, from the third apparatus, a second capacity response to the second capacity request, and means for binding the first apparatus and the third apparatus based on the second capacity response.

In some embodiments, the binding update information may include at least one of at least one binding information type, and an identity of the third apparatus.

In some embodiments, the apparatus may further include means for transmitting second binding information to the third apparatus, and the second binding information may include at least one of an identity of the first apparatus, and at least one binding information type.

In some embodiments, the first capacity request or the second capacity request may include at least one binding information type.

In some embodiments, the first capacity response or the second capacity response may include at least one of at least one supported binding information type, at least one rejected binding information type, and at least one reject reason.

In a tenth aspect, a computer readable medium is disclosed. The computer readable medium may include instructions stored thereon for causing an apparatus to perform transmitting, to a management entity, a binding request for binding with at least one neighboring apparatus, and receiving, from the management entity, a binding response to the binding request.

In some embodiments, the transmitting, to a management entity, a binding request for binding with at least one neighboring apparatus may be triggered by a predetermined event.

In some embodiments, the binding request may include at least one of an indicator of the binding request, at least one identity of the at least one neighboring apparatus, at least one binding information type, and at least one binding reason.

In some embodiments, the binding response may include at least one of acknowledge or negative acknowledge of the binding request, at least one binding information type, and at least one identity of the at least one neighboring apparatus.

In some embodiments, the computer readable medium may further include instructions stored thereon for causing an apparatus to further perform searching the at least one neighboring apparatus, and acquiring the at least one identity of the at least one neighboring apparatus.

In some embodiments, the computer readable medium may further include instructions stored thereon for causing an apparatus to further perform transmitting, to the management entity, a binding release request for de-binding with the at least one neighboring apparatus, and receiving, from the management entity, a binding release response to the binding release request.

In some embodiments, the binding release request may include at least one of an indicator of the binding release request, at least one binding information type to be release, and at least one binding release reason.

In some embodiments, the binding release response may include at least one of acknowledge of the binding release request, and at least one released binding information type.

In an eleventh aspect, disclosed is a computer readable medium. The computer readable medium may include instructions stored thereon for causing an apparatus to perform receiving, from a management entity, a capacity request for binding capacity with a neighboring apparatus, and transmitting, to the management entity, a capacity response to the capacity request.

In some embodiments, the capacity request may include at least one binding information type.

In some embodiments, the capacity response may include at least one of at least one supported binding information type, at least one rejected binding information type, and at least one reject reason.

In some embodiments, the computer readable medium may further include instructions stored thereon for causing an apparatus to further perform receiving binding information from the management entity.

In some embodiments, the binding information may include at least one of an identity of the neighboring apparatus, and at least one binding information type.

In some embodiments, the computer readable medium may further include instructions stored thereon for causing an apparatus to further perform transmitting, to the management entity, a binding release request for de-binding with the neighboring apparatus, and receiving, from the management entity, a binding release response to the binding release request.

In some embodiments, the binding release request may include at least one of an indicator of the binding release request, the identity of the neighboring apparatus, at least one binding information type to be release, and at least one binding release reason.

In some embodiments, the binding release response may include at least one of acknowledge of the binding release request, and at least one binding information type to be released.

In a twelfth aspect, disclosed is a computer readable medium. The computer readable medium may include instructions stored thereon for causing an apparatus to perform receiving, from a first apparatus, a binding request for binding with at least one neighboring apparatus of the first apparatus, transmitting, to a second apparatus of the at least one neighboring apparatus, a first capacity request for a binding capacity of the second apparatus, in response to the binding request, receiving, from the second apparatus, a first capacity response to the first capacity request, binding the first apparatus and the second apparatus based on the first capacity response, and transmitting, to the first apparatus, a binding response to the binding request.

In some embodiments, the binding request may include at least one of an indicator of the binding request, at least one identity of the at least one neighboring apparatus, at least one binding information type, and at least one binding reason.

In some embodiments, the binding response may include at least one of acknowledge or negative acknowledge of the binding request, at least one binding information type, and an identity of the second apparatus.

In some embodiments, the computer readable medium may further include instructions stored thereon for causing an apparatus to further perform receiving an access request for first measurement information of the first apparatus, transmitting the access request to the second apparatus, receiving second measurement information of the second apparatus, and determining the first measurement information based on the second measurement information and a calibration parameter.

In some embodiments, the binding the first apparatus and the second apparatus based on the first capacity response may include establishing an association between the first apparatus and at least one of an identity of the second apparatus, a binding information type, a calibration parameter, and binding establishment time.

In some embodiments, the computer readable medium may further include instructions stored thereon for causing an apparatus to further perform transmitting first binding information to the second apparatus, and the first binding information may include at least one of an identity of the first apparatus, and at least one binding information type.

In some embodiments, the computer readable medium may further include instructions stored thereon for causing an apparatus to further perform receiving, from one of the first apparatus and the second apparatus, a binding release request for de-binding the first apparatus and the second apparatus, deleting an association between the first apparatus and at least one of an identity of the second apparatus, a binding information type, a calibration parameter, and binding establishment time, based on the binding release request, transmitting, to the one of the first apparatus and the second apparatus, a binding release response to the binding release request, and transmitting, to another one of the first apparatus and the second apparatus, binding release information or binding update information.

In some embodiments, the binding release request may include at least one of an indicator of the binding release request, an identity of the first apparatus, at least one binding information type to be release, and at least one binding release reason.

In some embodiments, the binding release response may include at least one of acknowledge of the binding release request, and at least one released binding information type.

In some embodiments, the binding release information may include at least one released binding information type.

In some embodiments, the computer readable medium may further include instructions stored thereon for causing an apparatus to further perform transmitting, to a third apparatus of the at least one neighboring apparatus, a second capacity request for binding capacity of the third apparatus, in response to the binding release request from the second apparatus, receiving, from the third apparatus, a second capacity response to the second capacity request, and binding the first apparatus and the third apparatus based on the second capacity response.

In some embodiments, the binding update information may include at least one of at least one binding information type, and an identity of the third apparatus.

In some embodiments, the computer readable medium may further include instructions stored thereon for causing an apparatus to further perform transmitting second binding information to the third apparatus, and the second binding information may include at least one of an identity of the first apparatus, and at least one binding information type.

In some embodiments, the first capacity request or the second capacity request may include at least one binding information type.

In some embodiments, the first capacity response or the second capacity response may include at least one of at least one supported binding information type, at least one rejected binding information type, and at least one reject reason.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1A and FIG. 1B illustrate example scenarios in which embodiments of the present disclosure may be implemented.

FIG. 2 shows an exemplary sequence chart of apparatus binding establishment procedure according to an embodiment of the present disclosure.

FIG. 3 shows an exemplary sequence chart of position and/or perception information access procedure in established binding according to an embodiment of the present disclosure.

FIG. 4 shows an exemplary sequence chart of apparatus de-binding procedure according to an embodiment of the present disclosure.

FIG. 5 shows an exemplary sequence chart of apparatus de-binding procedure according to another embodiment of the present disclosure.

FIG. 6 shows an exemplary sequence chart of apparatus binding update procedure according to an embodiment of the present disclosure.

FIG. 7 shows a flow chart illustrating an example method for binding neighboring apparatuses according to an embodiment of the present disclosure.

FIG. 8 shows a flow chart illustrating an example method for binding neighboring apparatuses according to an embodiment of the present disclosure.

FIG. 9 shows a flow chart illustrating an example method for binding neighboring apparatuses according to an embodiment of the present disclosure.

FIG. 10 shows a block diagram illustrating an apparatus for binding and de-binding neighboring apparatuses according to an embodiment of the present disclosure.

FIG. 11 shows a block diagram illustrating an apparatus for binding and de-binding neighboring apparatuses according to an embodiment of the present disclosure.

FIG. 12 shows a block diagram illustrating an apparatus for binding and de-binding neighboring apparatuses according to an embodiment of the present disclosure.

FIG. 13 shows a block diagram illustrating an apparatus for binding neighboring apparatuses according to an embodiment of the present disclosure.

FIG. 14 shows a block diagram illustrating an apparatus for binding neighboring apparatuses according to an embodiment of the present disclosure.

FIG. 15 shows a block diagram illustrating an apparatus for binding neighboring apparatuses according to an embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

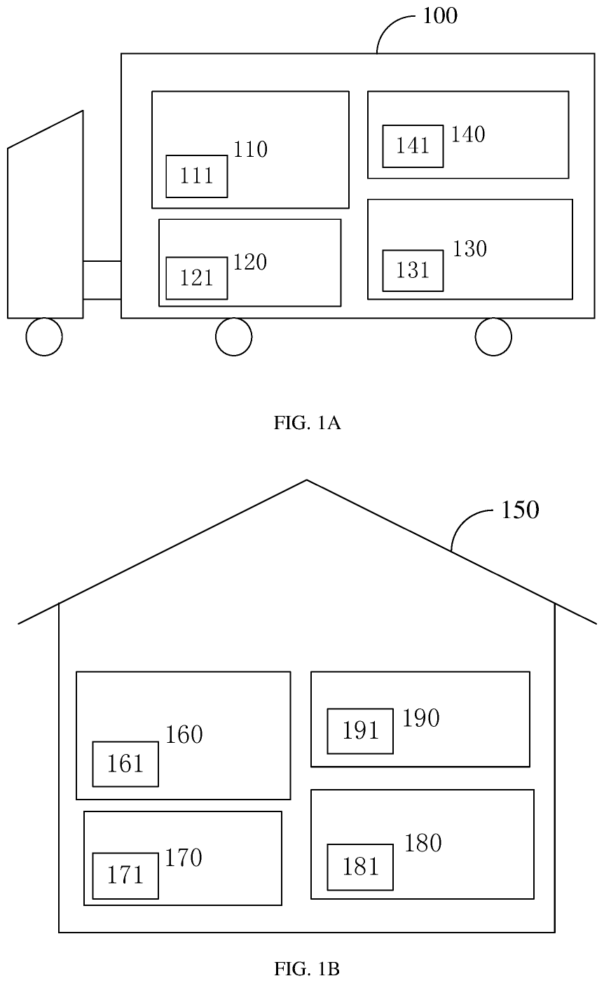

FIG. 1A and FIG. 1B illustrate example scenarios in which embodiments of the present disclosure may be implemented. FIG. 1A illustrates an example transportation scenario, in which a vehicle 100 is carrying a plurality of objects 110, 120, 130, and 140. The objects 110, 120, 130, and 140 are transported together and thus belong to the same transportation group. FIG. 1B illustrates an example stack scenario, in which a plurality of objects 160, 170, 180, and 190 are stacked in a warehouse 150. The objects 160, 170, 180, and 190 are stacked together and thus belong to the same stack group.

The objects 110, 120, 130, and 140 have apparatuses 111, 121, 131, and 141, respectively, and the objects 160, 170, 180, and 190 have apparatuses 161, 171, 181, and 191, respectively. The apparatuses 111, 121, 131, and 141, and the apparatuses 161, 171, 181, and 191 may measure position related information such as location, velocity, acceleration, etc. and/or environment perception related information such as barometric pressure, temperature, humility etc. of the objects 110, 120, 130, and 140, and the objects 110, 120, 130, and 140, respectively.

The apparatuses 111, 121, 131, and 141 may for example measure the same or approximate position related information such as location, velocity, acceleration, etc. of the respective objects 110, 120, 130, and 140 in the same transportation group. The apparatuses 161, 171, 181, and 191 may for example measure the same or approximate environment perception related information such as barometric pressure, temperature, humility etc. of respective objects 160, 170, 180, and 190 in the same stack group.

When an apparatus is suffering from lower power, sensor fault, sensor absence, bad communication channel, etc., it may request a management entity (for example, a location server or a location management entity in a core network) to bind or attach to one or more other apparatuses and utilize those other apparatuses to perform positioning and perception measurement. For example, such request may be a non-access stratum message.

For example, if the apparatus 121 has no sufficient power to measure velocity of the object 120, it may request the management entity to bind to one or more apparatuses on other objects in the same transportation group such as the apparatuses 111, 131, and 141. If the management entity binds the apparatus 121 to the apparatus 141 with respect to velocity, the apparatus 141 may measure velocity of the object 140, and velocity measurement information of the object 120 may be determined based on the measured velocity of the object 140.

For example, if the apparatus 161 has sensor fault and cannot measure temperature and humility of the object 160, it may request the management entity to bind to one or more apparatuses on other objects in the same stack group such as the apparatuses 171, 181, and 191. If the management entity binds the apparatus 161 to the apparatus 171 with respect to temperature and humility, the apparatus 171 may measure temperature and humility of the object 170, and temperature and humility measurement information of the object 160 may be based on the measured temperature and humility of the object 170.

One apparatus may be bound to different apparatuses with respect to different binding information types such as barometric pressure, temperature, humility etc.. In the above example scenario of FIG. 1B, alternatively, the management entity may bind the apparatus 161 to the apparatus 181 with respect to temperature and bind the apparatus 161 to the apparatus 191 with respect to humility, the apparatus 181 may measure temperature of the object 180 and the apparatus 191 may measure humility of the object 190, and temperature and humility measurement information of the object 160 may be based on the measured temperature of the object 180 and the measured humility of the object 190.

In the embodiments the object may be for example goods or other articles such as a box, etc., the apparatus may be for example a tag apparatus such as a hyper tag. The apparatus which cannot make measurement and is bound to other apparatus(es), e.g. the apparatuses 121 and 161 in the above scenarios of FIG. 1A and FIG. 1B, may be for example a lazy tag. The apparatus which is bound with a lazy tag to make measurement e.g. the apparatus 141 and the apparatuses 171, 181, and 191 in the above scenarios of FIG. 1A and FIG. 1B, may be for example a binding tag. The management entity may be for example location management function (LMF), a perception management entity, or other internet of things (IoT) management function. The vehicle 100 and the warehouse 150 are shown as examples, and it may be appreciated that the example embodiments can work for other carriers and platforms such as a ship, an aircraft, a workshop, etc.. In addition, four apparatuses attached to four objects are shown as an example in the scenario of FIG. 1A or FIG. 1B, and it may be appreciated that the example embodiments can work for more or less apparatuses.

In some embodiments, the apparatus of the object may communicate with the management entity via for example an access network (for example, including one or more base stations), and descriptions about the access network are omitted for the sake of conciseness.

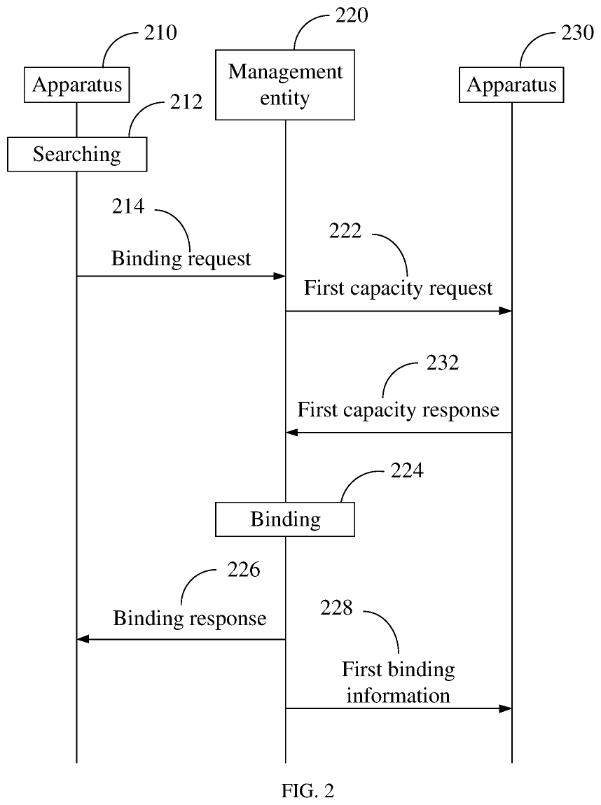

FIG. 2 shows an exemplary sequence chart of apparatus binding establishment procedure according to an embodiment of the present disclosure. Referring to FIG. 2, an apparatus 210 may be for example one of the apparatuses 111, 121, 131, and 141 described with reference to the FIG. 1A or one of the apparatuses 161, 171, 181, and 191 described with reference to the FIG. 1B.

The apparatus binding establishment procedure may be initialized by the apparatus 210 transmitting a binding request 214, which may be triggered by a predetermined event. The predetermined event may be for example lower power being measured, positioning or some environment perception sensor fault, positioning or some environment perception sensor absence, lower quality of communication channel, etc..

For example, the apparatus 210 may transmit the binding request 214 to a management entity 220 which may be the management entity described with reference to the FIG. 1A or FIG. 1B. The binding request 214 may request the management entity 220 to bind the binding request 214 with at least one neighboring apparatus.

The binding request 214 may for example include at least one of an indicator of the binding request 214, at least one identity of the at least one neighboring apparatus, at least one binding information type, and at least one binding reason. The at least one binding information type may be information of corresponding object to be measured by the apparatus 210 and include for example position related information such as location, velocity, acceleration, etc. and/or environment perception related information such as barometric pressure, temperature, humility, etc. The at least one binding reason may be the reason why the apparatus 210 cannot make a measurement of the corresponding object and include for example lower power, bad channel quality, sensor fault, sensor absence, etc..

For acquiring the at least one identity of the at least one neighboring apparatus, the apparatus 210 may search, in an operation 212, the at least one neighboring apparatus from the same transportation or stack group by means of suitable technique such as Bluetooth, wireless fidelity (Wi-Fi), Zigbee, sidelink communication and so on, for the at least one identity. Alternatively or in addition, the apparatus 210 may also be manually configured by transportation or stack manager about the at least one identity of the at least one neighboring apparatus.

Receiving the binding request 214, the management entity 220 may transmit, to an apparatus 230 of the at least one neighboring apparatus, a first capacity request 222 for a binding capacity of the apparatus 230. The apparatus 230 may be an example of one apparatus of the at least one neighboring apparatus. The first capacity request 222 may include the at least one binding information type in for example the binding request 214. By means of the first capacity request 222, the management entity 220 may request the binding capacity of the apparatus 230 in a form of polling based on the at least one identity of the at least one neighboring apparatus in the binding request 214. The first capacity request 222 may indicate the apparatus 230 which position and/or perception information type will be bound for the apparatus 210. The binding capacity may include power status, and work status of at least one position and/or perception sensor corresponding to the at least one binding information type, of the apparatus 230. The binding capacity may also include permission or prohibition, of the apparatus 230, to bind with the apparatus 210, which may be set by for example the owner of the corresponding object of the apparatus 230.

After receiving the first capacity request 222, the apparatus 230 may make a first capacity response 232 to the first capacity request 222. The first capacity response 232 may indicate the binding capacity of the apparatus 230, and may include at least one of at least one supported binding information type, at least one rejected binding information type, and at least one reject reason.

For example, if the first capacity request 222 includes binding information types of temperature and humility, and the apparatus 230 has sufficient power and normally operating sensors for respective binding information types and is permitted to be bound, the first capacity response 232 may include supported binding information types of e.g. temperature and humility. If the apparatus 230 has sufficient power and a normally operating sensor for temperature, but has a faulty sensor for humility or is prohibited to bound for the binding information type of humility, the first capacity response 232 may include a supported binding information type of temperature, a rejected binding information type of humility and corresponding reject reason such as a sensor fault or prohibition for the binding information type of humility.

The apparatus 230 may transmit the first capacity response 232 to the management entity 220. After collecting the first capacity response 232, in an operation 224 the management entity 220 may bind the apparatus 210 with the apparatus 230 based on the first capacity response 232.

For example, the management entity 220 may align the binding request 214 from the apparatus 210 with the first capacity response 232 from the apparatus 230. For one binding information type in the binding request 214, if one first capacity response 232 supports the binding request 214, the management entity 220 may bind the apparatus 210 with the apparatus 230 with respect to the binding information type.

In some examples, with respect to the binding information type, the management entity 220 may make measurements on the apparatus 210 and the apparatus 230 of at least one neighboring apparatus meeting the binding request 214, comparing the measurement information difference between the apparatus 210 and the apparatus 230 of the at least one neighboring apparatus, and select the apparatus 230 with a minimum measurement information difference to bind with the apparatus 210.

Alternatively, the management entity 220 may select the apparatus 230 to bind with the apparatus 210 based on other criteria, e.g., the apparatus 230 with most power, the apparatus 230 with closest distance from the apparatus 210, etc..

For example, in a case where more than one capacity responses satisfy the binding request 214 with respect to the binding information type, if the apparatus 230 has a power higher than to the power of the other apparatuses making satisfying capacity responses, or if the apparatus 230 is closer to the apparatus 210 than the other apparatuses making satisfying capacity responses, the management entity 220 may select the apparatus 230 as the apparatus to be bound with the apparatus 210.

In the operation 224, with respect to a binding information type, the management entity 220 may get measurement information of the apparatus 210 and the apparatus 230 and calculate measurement information difference between the apparatus 210 and the apparatus 230 as a calibration parameter.

For example, with respect to the binding information type of location, the management entity 220 may calculate location measurement information difference (Δx, Δy, Δz) between the apparatus 210 and the apparatus 230 as a calibration parameter for location calibration. For example, the management entity 220 may get location (x1, y1, z1) of the apparatus 210 and location (x0, y0, z0) of the apparatus 230, and calculate Δx=x1−x0, Δy=y1−y0, and Δz=z1−z0 as the calibration parameter for location.

For example, with respect to the binding information type of temperature, the management entity 220 may calculate temperature measurement information difference (ΔT) between the apparatus 210 and the apparatus 230 as the calibration parameter for temperature calibration. For example, the management entity 220 may get temperature T1 of the apparatus 210 and temperature T0 of the apparatus 230, and calculate ΔT=T1−T0 as the calibration parameter for temperature.

Alternatively or in addition, the calibration parameter may be configured by for example the transportation or stack manager. For example, the transportation or stack manager may input the calibration parameter for respective binding information type based on a mass of historical data.

Also in the operation 224, in the establishment of the binding between the apparatus 210 and the apparatus 230, the management entity 220 may establish an association between the apparatus 210 and at least one of the identity of the apparatus 230, the binding information type, the calibration parameter, and binding establishment time.

The management entity 220 may make a binding response 226 corresponding to the binding request 214 and transmit the binding response 226 to the apparatus 210. The binding response 226 may include at least one of acknowledge or negative acknowledge of the binding request 214, at least one binding information type, and an identity of the apparatus 230. If the binding request 214 include for example the binding information type of location and velocity, and the management entity 220 binds the apparatus 230 with respect to location and binds no apparatus with respect to velocity, the binding response 226 may include acknowledge of the binding request 214 for location and the identity of the apparatus 230, as well as negative acknowledge of the binding request 214 for velocity. It may be appreciated that the binding response 226 may be of other forms based on a different binding result.

The management entity 220 may further transmit first binding information 228 to the apparatus 230. The first binding information 228 may include at least one of an identity of the apparatus 210 and at least one binding information type. By means of the first binding information 228, the apparatus 230 may be informed of for example the identity of the apparatus 210 and the at least one binding information type for which it is bound with the apparatus 210.

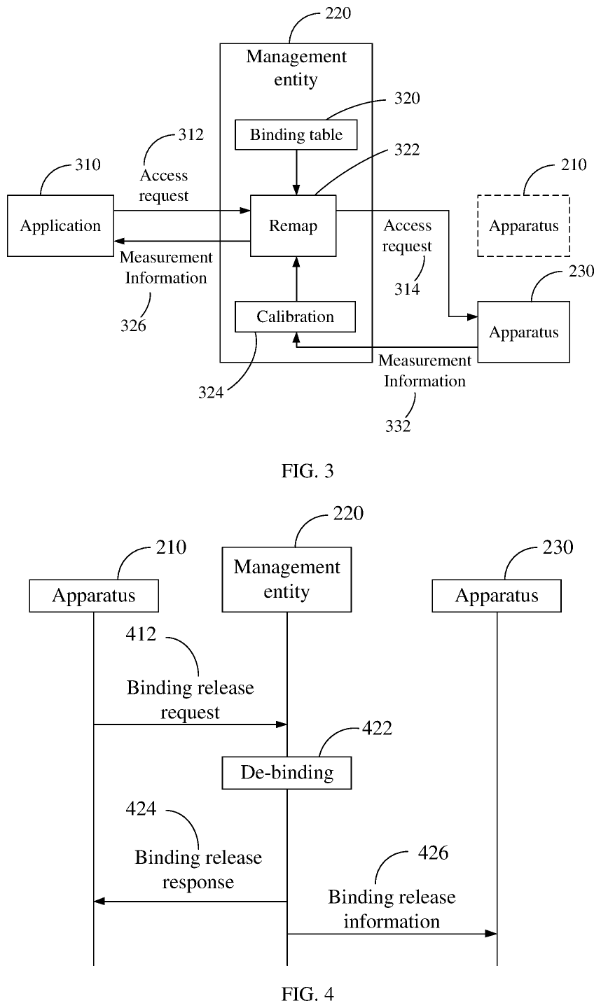

FIG. 3 shows an exemplary sequence chart of position and/or perception information access procedure in established binding according to an embodiment of the present disclosure.

Referring to FIG. 3, assuming an application 310 wants to get measurement information 326 about location, temperature, etc. of the apparatus 210, the application 310 may transmit an access request 312 to the management entity 220, and the access request 312 may include for example the identity of the apparatus 210 and expected measurement information type. The application 310 may be an application for example at user level, e.g. an application used for the owner of the object with the apparatus 210 or the transportation or stack manager to monitor the measurement information of the apparatus 210.

Receiving the access request 312, the management entity 220 may search a binding table 320 for a binding item matching the access request 312. The binding table 320 may be established in the operation 224 and maintained by the management entity 220. The binding table 320 may include a list of at least one binding item corresponding to the at least one association established in the operation 224 by the management entity 220. For example, a binding item in the binding table 320 may include information such as the identity of the apparatus 210, the identity of the apparatus 230, the binding information type, the calibration parameter, binding establishment time, etc.. If the identity of the apparatus 210 can be found in the binding item and the expected measurement information type matches the binding information type in that binding item, in a remap operation 322, the management entity 220 may make an access request 314 based on the access request 312 and route the access request 314 to the apparatus 230 based on the identity of the apparatus 230 in that binding item, rather than to the apparatus 210. For example, the access address for the access request 312 may be the apparatus 210 and the access address for the access request 314 may be changed to the apparatus 230.

In response to the access request 314 routed from the management entity 220, the apparatus 230 may make measurement of the binding information type and transmit measurement information 332 to the management entity 220.

Receiving the measurement information 332 of the apparatus 230, the management entity 220 may make measurement information 326 of the apparatus 210 based on the measurement information 332 without calibration, and transmit the measurement information 326 to the application 310. Alternatively, the management entity 220 may determine the measurement information 326 of the apparatus 210 based on the measurement information 332 of the apparatus 230 and the calibration parameter, and transmit the measurement information 326 to the application 310.

For example, the management entity 220 may make calibration 324 for the measurement information 332 based on the corresponding calibration parameter e.g. location measurement information difference (Δx, Δy, Δz) or temperature measurement information difference (A T) in that binding item, to determine the measurement information 326 and transmit the same to the application 310. For example, in a case where the measurement information is for location and the measurement information 332 is (x0′, y0′, z0′), the measurement information 326 may be (x0′+Δx, y0′+Δy, z0′+Δz). For example, in a case where the measurement information is for temperature and the measurement information 332 is T0′, the measurement information 326 may be T0′+ΔT.

The remap 322 may be transparent for the application 310. For example, the application 310 may be unaware that the measurement information 326 is determined from the measurement information 332 of the apparatus 230 and may for example suppose the measurement information 326 is from the apparatus 210.

FIG. 4 shows an exemplary sequence chart of apparatus de-binding procedure according to an embodiment of the present disclosure. After the binding between the apparatus 210 and the apparatus 230 is established, either the apparatus 210 or the apparatus 230 may initialize a de-binding procedure to release the binding. Some events may trigger the apparatus 210 to initialize the de-binding procedure. A triggering event may be that the reason for requesting the binding is eliminated on the apparatus 210, for example, power is recovered, communication channel quality is recovered, sensor fault is recovered, etc. The triggering event may also be that the binding is no longer useful, for example the apparatus 210 monitors that the position of the apparatus 230 has changed so that the measurement information of the apparatus 230 is not useful for determining the measurement information of the apparatus 210.

Referring to FIG. 4, in case that the de-binding procedure is initialized by the apparatus 210, the apparatus 210 may transmit a binding release request 412 for de-binding with the apparatus 230 to the management entity 220. The binding release request 412 may include at least one of an indicator of the binding release request 412, at least one binding information type to be released, and at least one binding release reason.

The apparatus 210 may indicate the management entity 220 fully binding release or partly binding release. For example, if due to lower power the apparatus 210 has been bound with the apparatus 230 with respect to the binding information types of barometric pressure, temperature and humility, and the apparatus 210 expects to release the binding for the binding information types of barometric pressure, temperature and humility with the apparatus 230 due to power recovery on the apparatus 210, the binding release request 412 may include an indicator of the binding release request 412, the binding information types to be released including barometric pressure, temperature and humility, and the binding release reason of power recovery.

For example, if due to sensor fault the apparatus 210 has been bound with the apparatus 230 with respect to the binding information types of barometric pressure, temperature and humility, and the apparatus 210 expects to release the binding for the binding information types of temperature and humility with the apparatus 230 due to sensor fault recovery of temperature and humility measurements and maintain the binding with respect to the barometric pressure because e.g. the barometric pressure measurement is still faulty, the binding release request 412 may include the indicator of the binding release request 412, the binding information types to be released including temperature and humility, and the binding release reason of sensor fault recovery. It may be appreciated that the apparatus 210 may also request to release the binding with some neighboring apparatus and keep the binding with some other neighboring apparatus.

In response to the binding release request 412, the management entity 220 may in an operation 422 de-bind the apparatus 210 with the apparatus 230. For example, based on the binding release request 412, the management entity 220 may delete from the binding table 320 shown in FIG. 3 the binding item including for example the binding information type to be released in the binding release request 412. For example, the association between the apparatus 210 and at least one of the identity of the apparatus 230, the binding information type, the calibration parameter, and binding establishment time, which corresponds to the binding item, may be deleted.

The management entity 220 may make a binding release response 424 corresponding to the binding release request 412 and transmit the binding release response 424 to the apparatus 210. The binding release response 424 may include at least one of acknowledge of the binding release request 412, and at least one released binding information type.

The management entity 220 may further transmit binding release information 426 to the apparatus 230. The binding release information 426 may include at least one released binding information type.

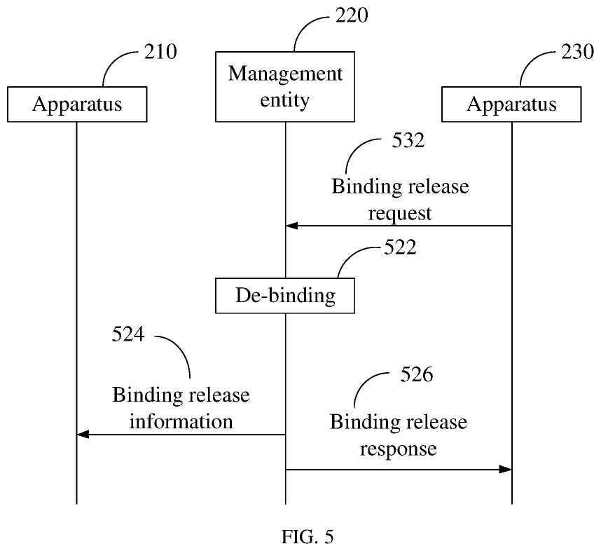

FIG. 5 shows an exemplary sequence chart of apparatus de-binding procedure according to another embodiment of the present disclosure. Some events may trigger the apparatus 230 to initialize the de-binding procedure. A triggering event may be that the apparatus 230 cannot bind with the apparatus 210. For example, the power or the communication channel quality of the apparatus 230 is low, sensor fault of the apparatus 230 occurs, etc. The triggering event may also be that the apparatus 230 is not permitted to bind with the apparatus 210 with respect to some binding information type, etc..

Referring to FIG. 5, in a case where the de-binding procedure is initialized by the apparatus 230, the apparatus 230 may transmit a binding release request 532 for de-binding with the apparatus 210 to the management entity 220. The binding release request 532 may include at least one of an indicator of the binding release request 532, the identity of the apparatus 210, at least one binding information type to be released, and at least one binding release reason.

Similar to the binding release request 412 from the apparatus 210, by means of the binding release request 532, the apparatus 230 may indicate the management entity 220 fully binding release or partly binding release with the apparatus 210. For example, assuming the apparatus 230 has been bound with the apparatus 210 with respect to the binding information types of location, velocity and acceleration, the apparatus 230 may request to de-bind with the apparatus 210 with respect to the binding information types of location, velocity and acceleration due to e.g. lower power of the apparatus 230, or the apparatus 230 may request to de-bind with the apparatus 210 with respect to velocity and acceleration due to e.g. sensor fault of velocity and acceleration measurements. It may be appreciated that the apparatus 230 may also request to release the binding with some neighboring apparatus and keep the binding with some other neighboring apparatus.

In response to the binding release request 532, the management entity 220 may in an operation 522 de-bind the apparatus 230 with the apparatus 210. The operation 522 is similar to the operation 422, for example, the management entity 220 may delete from the binding table 320 shown in FIG. 3 the binding item including for example the binding information type to be released in the binding release request 532, so that the association corresponding to the bind item is deleted. Details of the operations 522 may refer to the above descriptions with respect to the operation 422 shown in FIG. 4, and a repetitive description thereof is omitted here.

The management entity 220 may make a binding release response 526 corresponding to the binding release request 532 and transmit the binding release response 526 to the apparatus 230. The binding release response 526 may include at least one of acknowledge of the binding release request 532, and at least one released binding information type.

The management entity 220 may further transmit binding release information 524 to the apparatus 210. The binding release information 524 may include at least one released binding information type.

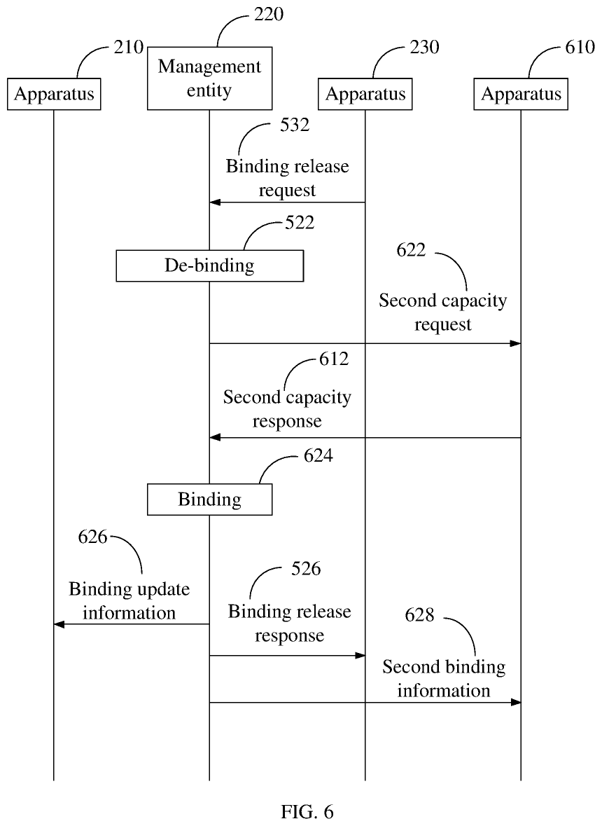

FIG. 6 shows an exemplary sequence chart of apparatus binding update procedure according to an embodiment of the present disclosure.

Referring back to FIG. 5, in case that the de-binding procedure is initialized by the apparatus 230, in response to the binding release request 532 from the apparatus 230, in addition to the operation 522 the management entity 220 may further try to find another neighboring apparatus to bind with the apparatus 210 with respect to the binding information type to be released with the apparatus 230. Referring back to FIG. 2, for example, in case that besides the identity of the apparatus 230, the binding request 214 from the apparatus 210 includes at least one identity of at least one neighboring apparatus, referring to FIG. 6, the management entity 220 may transmit, to an apparatus 610 of the at least one neighboring apparatus whose identity is in the binding request 214, a second capacity request 622 for the binding capacity of the apparatus 610.

The apparatus 610 may be an example of one apparatus of the at least one neighboring apparatus other than the apparatus 230. The second capacity request 622 may include at least one binding information type to be released with the apparatus 230. By means of the second capacity request 622, the management entity 220 may request the binding capacity of the apparatus 610 in a form of polling based on the at least one identity of the at least one neighboring apparatus in the binding request 214.

The second capacity request 622 may be similar to the first capacity request 222, and details of the second capacity request 622 may refer to the above descriptions with respect to the first capacity request 222 shown in FIG. 2, and a repetitive description thereof is omitted here.

Receiving the second capacity request 622, the apparatus 610 may make a second capacity response 612 in response to the second capacity request 622. The second capacity response 612 may indicate the binding capacity of the apparatus 610, and may include at least one of at least one supported binding information type, at least one rejected binding information type, and at least one reject reason.

The second capacity request 622 may be similar to the first capacity request 222, and details of the second capacity request 622 may refer to the above descriptions with respect to the first capacity request 222 shown in FIG. 2, and a repetitive description thereof is omitted here.

The apparatus 610 may transmit the second capacity response 612 to the management entity 220. After collecting the second capacity response 612, in an operation 624 the management entity 220 may bind the apparatus 210 with the apparatus 610 based on the second capacity response 612.

The operation 624 may be similar to the operation 224, and details of the operation 624 may refer to the above descriptions with respect to the operation 224 shown in FIG. 2, and a repetitive description thereof is omitted here.

In case that the binding request 214 shown in FIG. 2 includes no identity of neighboring apparatus other than that of the apparatus 230, the management entity 220 may not try to find another neighboring apparatus to bind with the apparatus 210 with respect to the binding information type to be released with the apparatus 230, and thus the second capacity request 622, the second capacity response 612 and related operations including the operation 624 may be omitted. In this case, the management entity 220 may directly transmit the binding release information 524 shown in FIG. 5 to the apparatus 210.

Alternatively, after collecting the second capacity response 612, if in the operation 624 the management entity 220 finds that according to the second capacity response 612, no binding information type in the second capacity request 622 can be supported, the management entity 220 may transmit the binding release information 524 shown in FIG. 5 to the apparatus 210.

Regardless of whether the management entity 220 may bind the apparatus 210 with the apparatus 610 in the operation 624, the management entity 220 may make a binding release response 526 corresponding to the binding release request 532 and transmit the binding release response 526 to the apparatus 230. The binding release response 526 may include at least one of acknowledge of the binding release request 532, and at least one released binding information type.

In a case where the management entity 220 binds the apparatus 210 with the apparatus 610 in the operation 624, the management entity 220 may transmit binding update information 626 to the apparatus 210. The binding update information may include at least one of at least one binding information type, and an identity of the apparatus 610. The at least one binding information type may the binding information type with respect to which the binding is released from the apparatus 230 in the operation 522 and established with the apparatus 610 in the operation 624.

The management entity 220 may further transmit second binding information 628 to the apparatus 610. The second binding information 228 may include at least one of an identity of the apparatus 210 and at least one binding information type. By means of the first binding information 228, the apparatus 230 may be informed of for example the identity of the apparatus 210 and the at least one binding information type for which it is bound with the apparatus 210.

In the embodiments, communication of request, response, information, etc. among the apparatus 210, the management entity 220, the apparatus 230, the apparatus 610, etc. may be via e.g. one or more none access stratum (NAS) messages according to e.g. long term evolution (LTE) positioning protocol (LPP). It may be appreciated that the communication may be via other suitable protocols, e.g. machine-type communication (MTC) protocol such as cellular IoT protocol.

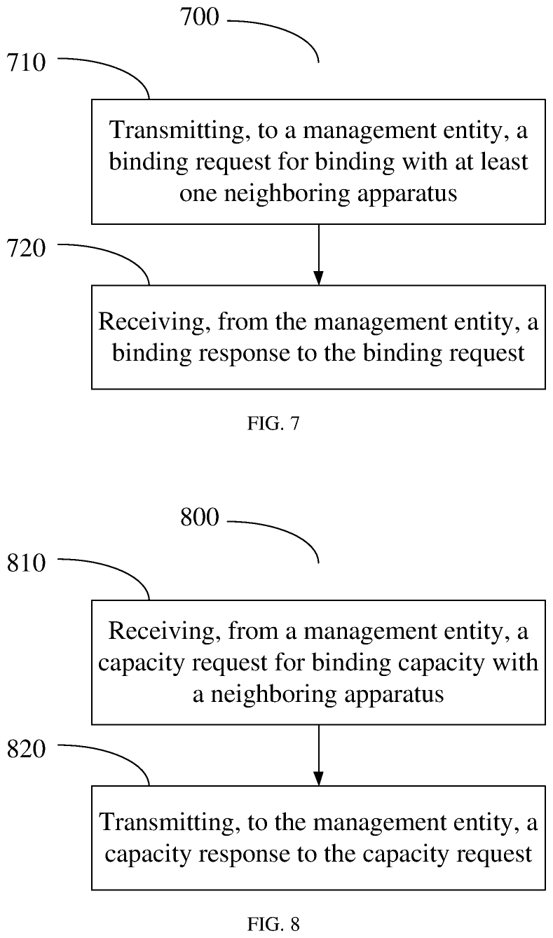

FIG. 7 shows a flow chart illustrating an example method 700 for binding neighboring apparatuses according to an embodiment of the present disclosure. The example method 700 may be performed for example at an apparatus such as the apparatus 210.

Referring to FIG. 7, the example method 700 may include an operation 710 of transmitting, to a management entity, a binding request for binding with at least one neighboring apparatus, and an operation 720 of receiving, from the management entity, a binding response to the binding request.

The operation 710 may be triggered by a predetermined event. The predetermined event may be for example lower power being measured, positioning or some environment perception sensor fault, positioning or some environment perception sensor absence, lower quality of communication channel, etc.

The management entity may be for example the management entity 220, the binding request may be for example the binding request 214, the binding response may be for example the binding response 226, and the at least one neighboring apparatus may include for example the apparatus 230. Details of the operations 710 and 720 may refer to the above descriptions with respect to the operations relating to the binding request 214 and the binding response 226, and a repetitive description thereof is omitted here.

In an embodiment, the binding request may include at least one of an indicator of the binding request, at least one identity of the at least one neighboring apparatus, at least one binding information type, and at least one binding reason. The more details may refer to the above descriptions with respect to the binding request 214, and a repetitive description thereof would be omitted here.

In an embodiment, the binding response may include at least one of acknowledge or negative acknowledge of the binding request, at least one binding information type, and at least one identity of the at least one neighboring apparatus. The more details may refer to the above descriptions with respect to the binding response 226, and a repetitive description thereof would be omitted here.

In an embodiment, the example method 700 may further include an operation of searching the at least one neighboring apparatus, and an operation of acquiring the at least one identity of the at least one neighboring apparatus. The more details may refer to the above descriptions with respect to the operation 212, and a repetitive description thereof would be omitted here.

In an embodiment, the example method 700 may further include an operation of transmitting, to the management entity, a binding release request for de-binding with the at least one neighboring apparatus, and an operation of receiving, from the management entity, a binding release response to the binding release request. The binding release request may be for example the binding release request 412, and the binding release response may be for example the binding release response 424. Details of the operations may refer to the above descriptions with respect to the operations relating to the binding release request 412 and the binding release response 424, and a repetitive description thereof is omitted here.

In an embodiment, the binding release request may include at least one of an indicator of the binding release request, at least one binding information type to be release, and at least one binding release reason. The more details may refer to the above descriptions with respect to the binding release request 412, and a repetitive description thereof would be omitted here.

In an embodiment, the binding release response may include at least one of acknowledge of the binding release request, and at least one released binding information type. The more details may refer to the above descriptions with respect to the binding release response 424, and a repetitive description thereof would be omitted here.

FIG. 8 shows a flow chart illustrating an example method 800 for binding neighboring apparatuses according to an embodiment of the present disclosure. The example method 800 may be performed for example at an apparatus such as the apparatus 230.

Referring to FIG. 8, the example method 800 may include an operation 810 of receiving, from a management entity, a capacity request for binding capacity with a neighboring apparatus, and an operation 820 of transmitting, to the management entity, a capacity response to the capacity request.

The management entity may be for example the management entity 220, the capacity request may be for example the first capacity request 222, the capacity response may be for example the first capacity response 232, and the neighboring apparatus may be for example the apparatus 210. Details of the operations 810 and 820 may refer to the above descriptions with respect to the operations relating to the first capacity request 222 and the first capacity response 232, and a repetitive description thereof is omitted here.

In an embodiment, the capacity request may include at least one binding information type. The more details may refer to the above descriptions with respect to the first capacity request 222, and a repetitive description thereof would be omitted here.

In an embodiment, the capacity response may include at least one of at least one supported binding information type, at least one rejected binding information type, and at least one reject reason. The more details may refer to the above descriptions with respect to the first capacity response 232, and a repetitive description thereof would be omitted here.

In an embodiment, the example method 800 may further include an operation of receiving binding information from the management entity. The binding information may be for example the first binding information 228. Details of the operation may refer to the above descriptions with respect to the operations relating to the first binding information 228, and a repetitive description thereof is omitted here.

In an embodiment, the binding information may include at least one of an identity of the neighboring apparatus, and at least one binding information type. The more details may refer to the above descriptions with respect to the first binding information 228, and a repetitive description thereof would be omitted here.

In an embodiment, the example method 800 may further include an operation of transmitting, to the management entity, a binding release request for de-binding with the neighboring apparatus, and an operation of receiving, from the management entity, a binding release response to the binding release request. The binding release request may be for example the binding release request 532, and the binding release response may be for example the binding release response 526. Details of the operations may refer to the above descriptions with respect to the operations relating to the binding release request 532 and the binding release response 526, and a repetitive description thereof is omitted here.

In an embodiment, the binding release request may include at least one of an indicator of the binding release request, the identity of the neighboring apparatus, at least one binding information type to be release, and at least one binding release reason. The more details may refer to the above descriptions with respect to the binding release request 532, and a repetitive description thereof would be omitted here.

In an embodiment, the binding release response may include at least one of acknowledge of the binding release request, and at least one binding information type to be released. The more details may refer to the above descriptions with respect to the binding release response 526, and a repetitive description thereof would be omitted here.

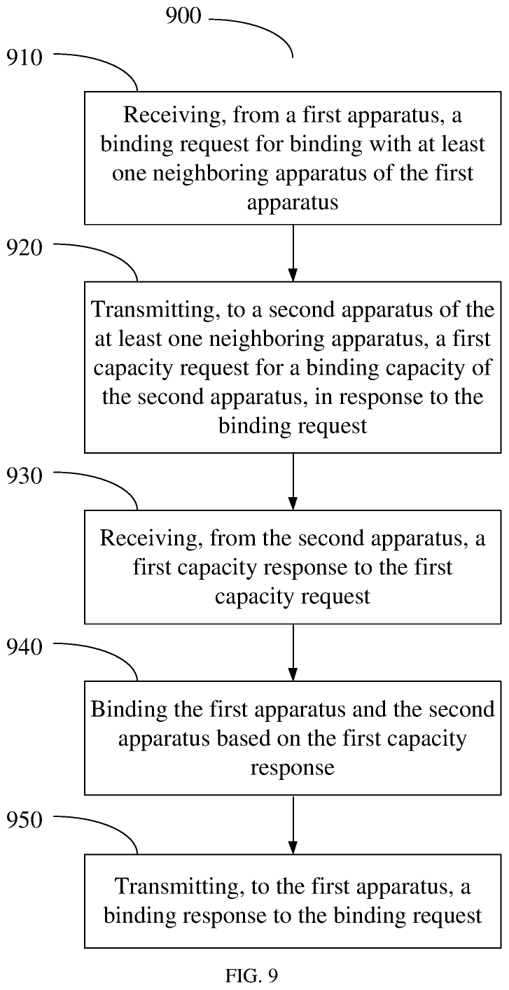

FIG. 9 shows a flow chart illustrating an example method 900 for binding neighboring apparatuses according to an embodiment of the present disclosure. The example method 900 may be performed for example at an apparatus such as the management entity 220.

Referring to FIG. 9, the example method 900 may include an operation 910 of receiving, from a first apparatus, a binding request for binding with at least one neighboring apparatus of the first apparatus, an operation 920 of transmitting, to a second apparatus of the at least one neighboring apparatus, a first capacity request for a binding capacity of the second apparatus, in response to the binding request, an operation 930 of receiving, from the second apparatus, a first capacity response to the first capacity request, an operation 940 of binding the first apparatus and the second apparatus based on the first capacity response, and an operation 950 of transmitting, to the first apparatus, a binding response to the binding request.

The first apparatus may be for example the apparatus 210, the second apparatus may be for example the apparatus 230, the binding request may be for example the binding request 214, the first capacity request may be for example the first capacity request 222, the first capacity response may be for example the first capacity response 232, and the binding response may be for example the binding response 226.

Details of the operation 910 may refer to the above descriptions with respect to the operations relating to the binding request 214, details of the operation 920 may refer to the above descriptions with respect to the operations relating to the first capacity request 222, details of the operation 930 may refer to the above descriptions with respect to the operations relating to the first capacity response 232, details of the operation 940 may refer to the above descriptions with respect to the operation 224, details of the operation 950 may refer to the above descriptions with respect to the operations relating to the binding response 226, and a repetitive description thereof is omitted here.

In an embodiment, the binding request may include at least one of an indicator of the binding request, at least one identity of the at least one neighboring apparatus, at least one binding information type, and at least one binding reason. The more details may refer to the above descriptions with respect to the binding request 214, and a repetitive description thereof would be omitted here.

In an embodiment, the binding response may include at least one of acknowledge or negative acknowledge of the binding request, at least one binding information type, and an identity of the second apparatus. The more details may refer to the above descriptions with respect to the binding response 226, and a repetitive description thereof would be omitted here.

In an embodiment, the example method 900 may further include an operation of receiving an access request for first measurement information of the first apparatus, an operation of transmitting the access request to the second apparatus, an operation of receiving second measurement information of the second apparatus, and an operation of determining the first measurement information based on the second measurement information and a calibration parameter. The access request may be for example the access request 312, the first measurement information may be for example the measurement information 326, and the second measurement information may be for example the measurement information 332. Details of the operations may refer to the above descriptions with respect to the operations relating to the access request 312, the measurement information 326, the measurement information 332, the binding table 320, the remap 322, and the calibration 324, and a repetitive description thereof is omitted here.

In an embodiment, the binding the first apparatus and the second apparatus based on the first capacity response may include establishing an association between the first apparatus and at least one of an identity of the second apparatus, a binding information type, a calibration parameter, and binding establishment time. The more details may refer to the above descriptions with respect to the operation 224, and a repetitive description thereof would be omitted here.

In an embodiment, the example method 900 may further include an operation of transmitting first binding information to the second apparatus, and the first binding information may include at least one of an identity of the first apparatus, and at least one binding information type. The first binding information may be the first binding information 228. The more details may refer to the above descriptions with respect to the first binding information 228, and a repetitive description thereof would be omitted here.

In an embodiment, the example method 900 may further include an operation of receiving, from one of the first apparatus and the second apparatus, a binding release request for de-binding the first apparatus and the second apparatus, an operation of deleting an association between the first apparatus and at least one of an identity of the second apparatus, a binding information type, a calibration parameter, and binding establishment time, based on the binding release request, an operation of transmitting, to the one of the first apparatus and the second apparatus, a binding release response to the binding release request, and an operation of transmitting, to another one of the first apparatus and the second apparatus, binding release information or binding update information.

The binding release request may be for example the binding release request 412 or the binding release request 532, the binding release response may be for example the binding release response 424 or the binding release response 526, the binding release information may be for example the binding release information 426 or the binding release information 524, and the binding update information may be for example the binding update information 626. Details of the operations may refer to the above descriptions with respect to the operations relating to the binding release request 412, the binding release request 532, the binding release response 424, the binding release response 526, the binding release information 426, the binding release information 524, and the binding update information 626, as well as the operation 522, and a repetitive description thereof would be omitted here.

In an embodiment, the binding release request may include at least one of an indicator of the binding release request, an identity of the first apparatus, at least one binding information type to be release, and at least one binding release reason. The more details may refer to the above descriptions with respect to the binding release request 412 or the binding release request 532, and a repetitive description thereof would be omitted here.

In an embodiment, the binding release response may include at least one of acknowledge of the binding release request, and at least one released binding information type. The more details may refer to the above descriptions with respect to the binding release response 424 or the binding release response 526, and a repetitive description thereof would be omitted here.

In an embodiment, the binding release information may include at least one released binding information type. The more details may refer to the above descriptions with respect to the binding release information 426 or the binding release information 524, and a repetitive description thereof would be omitted here.

In an embodiment, the example method 900 may further include an operation of transmitting, to a third apparatus of the at least one neighboring apparatus, a second capacity request for binding capacity of the third apparatus, in response to the binding release request from the second apparatus, an operation of receiving, from the third apparatus, a second capacity response to the second capacity request, and an operation of binding the first apparatus and the third apparatus based on the second capacity response.

The third apparatus may be for example the apparatus 610, the second capacity request may be for example the second capacity request 622, the binding release request may be for example the binding release request 532, and the second capacity response may be for example the second capacity response 612. Details of the operations may refer to the above descriptions with respect to the operations relating to the second capacity request 622, the binding release request 532, and the second capacity response 612, as well as the operation 624, and a repetitive description thereof would be omitted here.

In an embodiment, the binding update information may include at least one of at least one binding information type, and an identity of the third apparatus. The more details may refer to the above descriptions with respect to the binding update information 626, and a repetitive description thereof would be omitted here.

In an embodiment, the example method 900 may further include an operation of transmitting second binding information to the third apparatus, and the second binding information comprising at least one of an identity of the first apparatus, and at least one binding information type. The second binding information may be the second binding information 628. The more details may refer to the above descriptions with respect to the second binding information 628, and a repetitive description thereof would be omitted here.

In an embodiment, the first capacity request or the second capacity request may include at least one binding information type. The more details may refer to the above descriptions with respect to the first capacity request 222 or the second capacity request 622, and a repetitive description thereof would be omitted here.

In an embodiment, the first capacity response or the second capacity response comprises at least one of at least one supported binding information type, at least one rejected binding information type, and at least one reject reason. The more details may refer to the above descriptions with respect to the first capacity response 232 or the second capacity response 612, and a repetitive description thereof would be omitted here.

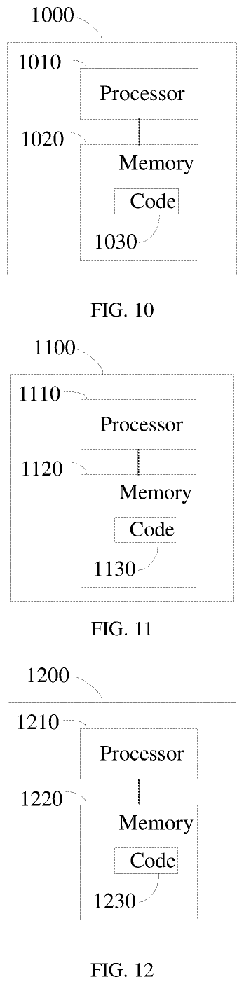

FIG. 10 shows a block diagram illustrating an apparatus for binding and de-binding neighboring apparatuses according to an embodiment of the present disclosure. The apparatus, for example, may be the at least part of the apparatus 210 in the above examples.

As shown in FIG. 10, the example apparatus 1000 may include at least one processor 1010 and at least one memory 1020 that may include computer program code 1030. The at least one memory 1020 and the computer program code 1030 may be configured to, with the at least one processor 1010, cause the apparatus 1000 at least to perform the example method 700 described above.

In various example embodiments, the at least one processor 1010 in the example apparatus 1000 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1010 may also include at least one other circuitry or element not shown in FIG. 10.

In various example embodiments, the at least one memory 1020 in the example apparatus 1000 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 820 may include, but are not limited to, an electric, a magnetic, an optical, an electromagnetic, an infrared, or a semiconductor system, apparatus, or device or any combination of the above.

Further, in various example embodiments, the example apparatus 1000 may also include at least one other circuitry, element, and interface, for example at least one I/O interface, at least one antenna element, and the like.

In various example embodiments, the circuitries, parts, elements, and interfaces in the example apparatus 1000, including the at least one processor 1010 and the at least one memory 1020, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the apparatus 210 is not limited to the above example apparatus 1000.

FIG. 11 shows a block diagram illustrating an apparatus for binding and de-binding neighboring apparatuses according to an embodiment of the present disclosure. The apparatus, for example, may be at least part of the apparatus 230 in the above examples.

As shown in FIG. 11, the example apparatus 1100 may include at least one processor 1110 and at least one memory 1120 that may include computer program code 1130. The at least one memory 1120 and the computer program code 1130 may be configured to, with the at least one processor 1110, cause the apparatus 1100 at least to perform at least one of the example method 800 described above.

In various example embodiments, the at least one processor 1110 in the example apparatus 1100 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1110 may also include at least one other circuitry or element not shown in FIG. 11.

In various example embodiments, the at least one memory 1120 in the example apparatus 1100 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 1120 may include, but are not limited to, an electric, a magnetic, an optical, an electromagnetic, an infrared, or a semiconductor system, apparatus, or device or any combination of the above.

Further, in various example embodiments, the example apparatus 1100 may also include at least one other circuitry, element, and interface, for example at least one I/O interface, at least one antenna element, and the like.

In various example embodiments, the circuitries, parts, elements, and interfaces in the example apparatus 1100, including the at least one processor 1110 and the at least one memory 1120, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the apparatus 230 is not limited to the above example apparatus 1100.

FIG. 12 shows a block diagram illustrating an apparatus for binding and de-binding neighboring apparatuses according to an embodiment of the present disclosure. The apparatus, for example, may be at least part of the management entity 220 in the above examples.

As shown in FIG. 12, the example apparatus 1200 may include at least one processor 1210 and at least one memory 1220 that may include computer program code 1230. The at least one memory 1220 and the computer program code 1230 may be configured to, with the at least one processor 1210, cause the apparatus 1200 at least to perform at least one of the example method 900 described above.

In various example embodiments, the at least one processor 1210 in the example apparatus 1200 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 1210 may also include at least one other circuitry or element not shown in FIG. 12.

In various example embodiments, the at least one memory 1220 in the example apparatus 1200 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 1220 may include, but are not limited to, an electric, a magnetic, an optical, an electromagnetic, an infrared, or a semiconductor system, apparatus, or device or any combination of the above.

Further, in various example embodiments, the example apparatus 1200 may also include at least one other circuitry, element, and interface, for example at least one I/O interface, at least one antenna element, and the like.

In various example embodiments, the circuitries, parts, elements, and interfaces in the example apparatus 1200, including the at least one processor 1210 and the at least one memory 1220, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the management entity 220 is not limited to the above example apparatus 1200.

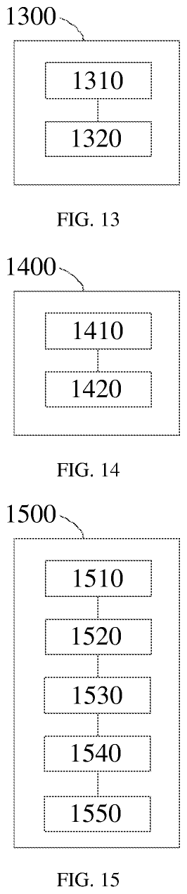

FIG. 13 shows a block diagram illustrating an apparatus for binding neighboring apparatuses according to an embodiment of the present disclosure. The apparatus, for example, may be at least part of the apparatus 210 in the above examples.

As shown in FIG. 13, the example apparatus 1300 may include means 1310 for performing the operation 710 of the example method 700, and means 1320 for performing the operation 720 of the example method 700. In one or more another example embodiments, at least one I/O interface, at least one antenna element, and the like may also be included in the example apparatus 1300.

In some example embodiments, examples of means in the example apparatus 1300 may include circuitries. For example, an example of means 1310 may include a circuitry configured to perform the operation 710 of the example method 700, and an example of means 1320 may include a circuitry configured to perform the operation 720 of the example method 700. In some example embodiments, examples of means may also include software modules and any other suitable function entities.

FIG. 14 shows a block diagram illustrating an apparatus for binding neighboring apparatuses according to an embodiment of the present disclosure. The apparatus, for example, may be at least part of the apparatus 230 in the above examples.

As shown in FIG. 14, the example apparatus 1400 may include means 1410 for performing the operation 810 of the example method 800, and means 1420 for performing the operation 820 of the example method 800. In one or more another example embodiments, at least one I/O interface, at least one antenna element, and the like may also be included in the example apparatus 1400.

In some example embodiments, examples of means in the example apparatus 1400 may include circuitries. For example, an example of means 1410 may include a circuitry configured to perform the operation 810 of the example method 800, and an example of means 1420 may include a circuitry configured to perform the operation 820 of the example method 800. In some example embodiments, examples of means may also include software modules and any other suitable function entities.

FIG. 15 shows a block diagram illustrating an apparatus for binding neighboring apparatuses according to an embodiment of the present disclosure. The apparatus, for example, may be at least part of the management entity 220 in the above examples.

As shown in FIG. 15, the example apparatus 1500 may include means 1510 for performing the operation 910 of the example method 900, means 1520 for performing the operation 920 of the example method 900, means 1530 for performing the operation 930 of the example method 900, means 1540 for performing the operation 940 of the example method 900, and means 1550 for performing the operation 950 of the example method 900. In one or more another example embodiments, at least one I/O interface, at least one antenna element, and the like may also be included in the example apparatus 1500.

In some example embodiments, examples of means in the example apparatus 1500 may include circuitries. For example, an example of means 1510 may include a circuitry configured to perform the operation 910 of the example method 900, an example of means 1520 may include a circuitry configured to perform the operation 920 of the example method 900, an example of means 1530 may include a circuitry configured to perform the operation 930 of the example method 900, an example of means 1540 may include a circuitry configured to perform the operation 940 of the example method 900, and an example of means 1550 may include a circuitry configured to perform the operation 950 of the example method 900. In some example embodiments, examples of means may also include software modules and any other suitable function entities.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and acts of the some embodiments described above can be combined to provide further embodiments. The accompanying claims and their equivalents are intended to cover such forms or modifications as would fall within the scope and spirit of the disclosure.

1. An apparatus, comprising:
at least one processor; and
at least one non-transitory memory storing instructions that, when executed with the at least one processor, cause the apparatus to perform:
transmitting, to a management entity, a binding request for binding with at least one neighboring apparatus; and
receiving, from the management entity, a binding response to the binding request.

2. The apparatus of claim 1, wherein the instructions, when executed with the at least one processor, cause the apparatus to perform the transmitting with triggering with a predetermined event.

3. The apparatus of claim 1, wherein the binding request comprises at least one of an indicator of the binding request, at least one identity of the at least one neighboring apparatus, at least one binding information type, or at least one binding reason; and
wherein the binding response comprises at least one of acknowledge or negative acknowledge of the binding request, at least one binding information type, or at least one identity of the at least one neighboring apparatus.

4. An apparatus, comprising:
at least one processor; and
at least one non-transitory memory storing instructions that, when executed with the at least one processor, cause the apparatus to perform:
receiving, from a management entity, a capacity request for binding capacity with a neighboring apparatus; and
transmitting, to the management entity, a capacity response to the capacity request.

5. The apparatus of claim 4, wherein the capacity request comprises at least one binding information type; and
wherein the capacity response comprises at least one of at least one supported binding information type, at least one rejected binding information type, or at least one reject reason.

6. An apparatus, comprising:
at least one processor; and
at least one non-transitory memory storing instructions that, when executed with the at least one processor, cause the apparatus to perform:
receiving, from a first apparatus, a binding request for binding with at least one neighboring apparatus of the first apparatus;
transmitting, to a second apparatus of the at least one neighboring apparatus, a first capacity request for a binding capacity of the second apparatus, in response to the binding request;
receiving, from the second apparatus, a first capacity response to the first capacity request;
binding the first apparatus and the second apparatus based on the first capacity response; and
transmitting, to the first apparatus, a binding response to the binding request.

7. The apparatus of claim 6, wherein the binding request comprises at least one of an indicator of the binding request, at least one identity of the at least one neighboring apparatus, at least one binding information type, or at least one binding reason; and
wherein the binding response comprises at least one of acknowledge or negative acknowledge of the binding request, at least one binding information type, or an identity of the second apparatus.

8. The apparatus of claim 6, wherein the instructions, when executed with the at least one processor, cause the apparatus to further perform:
receiving an access request for first measurement information of the first apparatus;
transmitting the access request to the second apparatus;
receiving second measurement information of the second apparatus; and
determining the first measurement information based on the second measurement information and a calibration parameter.

9. The apparatus of claim 6, wherein the instructions, when executed with the at least one processor, cause the apparatus to perfom:
establishing an association between the first apparatus and at least one of an identity of the second apparatus, a binding information type, a calibration parameter, or binding establishment time.

10. The apparatus of claim 6, wherein the at instructions, when executed with the at least one processor, cause the apparatus to further perform:
receiving, from one of the first apparatus and the second apparatus, a binding release request for de-binding the first apparatus and the second apparatus;
deleting an association between the first apparatus and at least one of an identity of the second apparatus, a binding information type, a calibration parameter, or binding establishment time, based on the binding release request;
transmitting, to the one of the first apparatus and the second apparatus, a binding release response to the binding release request; and
transmitting, to another one of the first apparatus and the second apparatus, binding release information or binding update information.

11. The apparatus of claim 10, wherein the instructions, when executed with the at least one processor, cause the apparatus to further perform:
transmitting, to a third apparatus of the at least one neighboring apparatus, a second capacity request for binding capacity of the third apparatus, in response to the binding release request from the second apparatus;
receiving, from the third apparatus, a second capacity response to the second capacity request; and
binding the first apparatus and the third apparatus based on the second capacity response.

12. The apparatus of claim 11, wherein the first capacity request or the second capacity request comprises at least one binding information type; and
the first capacity response or the second capacity response comprises at least one of at least one supported binding information type, at least one rejected binding information type, or at least one reject reason.

13. A method comprising:
transmitting, to a management entity, a binding request for binding with at least one neighboring apparatus; and
receiving, from the management entity, a binding response to the binding request.

14. The method of claim 13, wherein the transmitting, to a management entity, a binding request for binding with at least one neighboring apparatus is triggered with a predetermined event.

15. (canceled)

16. A method comprising:
receiving, from a management entity, a capacity request for binding capacity with a neighboring apparatus; and
transmitting, to the management entity, a capacity response to the capacity request.

17. The method of claim 16, wherein the capacity request comprises at least one binding information type; and
wherein the capacity response comprises at least one of at least one supported binding information type, at least one rejected binding information type, or at least one reject reason.

18. A method comprising:
receiving, from a first apparatus, a binding request for binding with at least one neighboring apparatus of the first apparatus;
transmitting, to a second apparatus of the at least one neighboring apparatus, a first capacity request for a binding capacity of the second apparatus, in response to the binding request;
receiving, from the second apparatus, a first capacity response to the first capacity request;
binding the first apparatus and the second apparatus based on the first capacity response; and
transmitting, to the first apparatus, a binding response to the binding request.

19. (canceled)

20. (canceled)

21. (canceled)

22. (canceled)

23. (canceled)

24. (canceled)

25. (canceled)

26. (canceled)

27. (canceled)

28. A non-transitory program storage device readable with an apparatus tangibly embodying a program of instructions executable with the apparatus for performing the method of claim 13.

29. A non-transitory program storage device readable with an apparatus tangibly embodying a program of instructions executable with the apparatus for performing the method of claim 16.

30. A non-transitory program storage device readable with an apparatus tangibly embodying a program of instructions executable with the apparatus for performing the method of claim 18.
